(19) United States
(12) Patent Application Publication
(10) Pub. No.: US 2005/0253113 A1
(43) Pub. Date: Nov. 17, 2005

(54) Rare earth doped luminescent glass

(76) Inventors: Martin Letz, Klein-Winterheim (DE); Ulrich Peuchert, Bodenheim (DE); Markus Schweizer, Stegen (DE); Bernd Drapp, Reutlingen (DE); Wolfram Beier, Essenheim (DE); Karina Seneschal, Mainz (DE); Axel Engel, Ingelheim (DE); Joseph S. Hayden, Clarks Summit, PA (US); Carol Click, Clarks Green, PA (US)

Correspondence Address: HARNESS, DICKEY & PIERCE, P.L.C., P.O. BOX 828, BLOOMFIELD HILLS, MI, 48303, US

(21) Appl. No.: 11/116,044

(22) Filed: Apr. 27, 2005

Related U.S. Application Data
(63) Continuation-in-part of application No. 10/798,940, filed on Mar. 11, 2004.

(30) Foreign Application Priority Data
Mar. 13, 2003 (DE) 103 11 820.9-33

(51) Int. Cl. C09K 3/00; C09K 11/08; C03C 3/23

(52) U.S. Cl. 252/301.4 P; 252/301.6 P; 252/301.4 H; 252/301.4 R; 252/301.4 F; 252/301.4 S; 501/43; 501/48; 501/50; 501/44; 501/64; 501/72; 501/60; 501/73; 501/74; 501/78

(57) ABSTRACT

A white cold light source uses an LED or a gas discharge lamp and a luminescent rare earth doped glass comprising multiple rare earth cations and a particularly high total rare earth content to generate white light emission. Preferably, the luminescent glass has a 2700K to 7000K black body temperature and color rendering index value exceeding 80. A first embodiment of the glass is composed primarily of P₂O₅, Al₂O₃, and alkaline earth and alkali metal oxides, and possesses other properties such as physical and thermal properties that are compatible with conventional melting, forming and other manufacturing steps. Other embodiments of the luminescent glass have a maximum water content of 0.1 wt-% and do not contain any boron. Also the luminescent glass is preferably free of water, boron oxides and nitrides. The luminescent glass can be used as a wavelength converter to produce bright white light emission when pumped by conventional commercially available blue and UV light emitting diode sources.

### RELATED APPLICATIONS

This application is a continuation-in-part application of copending U.S. patent application Ser. No. 10/798,940 filed on Mar. 11, 2004, claiming convention priority of German Patent Application DE 103 11 820.9 filed on Mar. 13, 2003, the contents of which are fully incorporated herein by reference.

### FIELD OF THE INVENTION

The invention relates to rare earth doped luminescent glasses and methods of generating white light in a system using such luminescent glasses in combination with cold light sources such as light emitting diodes (LEDs) emitting blue and/or UV light or such as gas discharge lamps.

### BACKGROUND OF THE INVENTION

In the lighting industry there is a continuous demand for the increase in power efficiency. Therefore, prior art incandescent light sources are being more and more replaced by more power efficient light sources such as LEDs and gas discharge lamps.

In particular, LEDs are becoming increasingly popular as light sources for lighting applications ranging from interior illumination, appliance indicators, displays, to outdoor high intensity lighting such as needed in automotive, aerospace, and recreational facilities. A limitation of commercial LEDs is that they produce light of limited spectral range (e.g. red, green or blue), and for many applications it is both desirable and necessary that the illumination source produce instead white light with a blackbody temperature between 2700 K and 3000K and a high color rendering index.

White light LEDs can be prepared in a number of ways. One way is to combine two monochromatic colors (for example blue and yellow) called complementary colors. Two such complementary colors at the appropriate ratio of intensities will be perceived as white light by the human eye. In the case of a white LED, this is achieved by using a blue LED in combination with a phosphor material that converts a portion of the blue LED light into yellow fluorescence. The resultant blue/yellow emission is perceived as white to the eye. The typical phosphor for this application is yttrium aluminum garnet (YAG) crystals doped with cerium (see for example “The Blue Laser Diode”, S. Nakamura and G. Fasol, Springer, 1997). Such sources lack red and green components giving poor color rendering properties.

Other phosphor materials include organic dyes and semiconductor nano particles. These have the advantage that they provide an opportunity to combine multiple colors to create white emission. However, all of these phosphor materials must be placed in a suitable encapsulate, including the cerium doped YAG. Commonly this is an organic plastic, with limited temperature stability and little resistance to chemical and mechanical degradation when exposed for extended periods of time to UV and blue light.

Alternatively, the possibility exists to dope glass with rare earth cations to produce white fluorescence. A number of rare earth doped glass formulations are known, with particular applicability as ophthalmic, filter, laser, upconversion and phosphors. However none of the prior art discusses use of these rare earth formulations for creating white light of sufficiently high quality to function in indoor illumination applications. For example, JP 2000159543 discloses a silicate glass ceramic containing rare earth cations for producing desirable long lasting luminescence. JP 2000281382 discloses silicate glasses and glass ceramics containing rare earth cations for producing desirable long lasting luminescence. EP 0 847 964 A1 and JP 8133780 A disclose silicate glasses containing europium or terbium, while EP 0 709 345 A1 and JP 9202642 A disclose fluorophosphate compositions containing either europium or terbium to produce fluorescent glasses of specific colors. EP 0 775 673 A1 and JP 10167755 A disclose fluorophosphate glass compositions containing europium in the divalent state, or terbium along with either samarium or manganese, to produce glasses that give blue or white fluorescence, respectively, when excited in the UV part of the spectrum to be used as an indicator card for identification of the location of UV laser beams.

From U.S. 2003/0025449 A1 a hybrid LED is known that comprises a radiation-emitting semiconductor body which is surrounded by a housing which comprises a glass body made of a luminescent glass for converting the UV radiation into visible light. However, any specific composition for the luminescent glass is not disclosed. A similar LED is known from JP 2002246651 A.

Further reference is made to JP 2001214162 A which discloses a phosphor comprising oxynitride glass as a matrix material. The glass comprises 20 to 50 mol-% of CaCO₃, up to 30 mol-% of Al₂O₃, 25 to 60 mol-% of SiO₂, 5 to 50 mol-% of AIN and 0.1 to 20 mol-% of rare earth or transition metals.

### SUMMARY OF THE INVENTION

The current invention relates to the use of particular types of rare earth containing glasses in combination with cold light sources that emit colored light, such as UV/blue LEDs, to generate light of different wavelengths, in particular to generate white light.

Accordingly, it is a first object of the invention to disclose improved luminescent glasses that are highly effective in the conversion of light.

It is a second object of the invention to disclose a cold white light source employing a rare earth doped luminescent glass as a wavelength conversion material.

It is a third object of the invention to provide improved white LED or gas-discharge systems that employ a luminescent glass, that may contain high concentrations of multiple rare earth ions and possess other properties such as physical and thermal properties that are compatible with conventional melting, forming and manufacturing procedures.

A further object of the invention is to provide improved white LED or other cold light systems in which a doped rare earth containing luminescent glass, in particular a phosphor glass, in the form of rod, disk, powder or film structure is placed adjacent to one or more UV or blue LED or other cold light source and functions as a wavelength conversion material to produce white light.

These and other objects are achieved according to the invention by a luminescent glass comprising a base glass doped with 0.001 to 30 wt.-% of rare earth oxides on an oxide basis, said base glass comprising 1 wt.-% of water at the most and 1 wt.-% of B₂O₃ at the most. Preferably, the glass does not contain any water at all (0.1 wt-% or 0.01 wt.-% at the most). Also preferably, the glass does not contain any B₂O₃ (0.1 wt-% or 0.01 wt.-% at the most).

Such glasses facilitate an optimization of the glasses with respect to a high UV-transmissivity and to a low maximum phonon energy. Thus the losses of the luminescent glass body are kept as small as possible.

The glasses may be optimized with respect to their maximum phonon energy which should be kept as small as possible thus reducing losses. In case excitation of the luminescent glass is performed in the UV-region then the luminescent glass can also be optimized with respect to a high UV-transmissivity.

Preferably, the luminescent glass is used as a solid glass body thus leading to a good optical homogeneity, to a high mechanical, thermal, and chemical resistance as well as to a long-term stability of the absorption and emission characteristics.

The cold light source may be an LED or any other cold light source, such as a gas-discharge lamp, a neon lamp, etc.

In case LEDs are used, then preferably LEDs emitting in the blue and UV-region are used in combination with the luminescent glass according to the invention to produce high-power white LED sources.

The rare earth doping used to obtain the luminescent characteristic of the glass is preferably as high as possible to obtain a highly effective conversion and a bright light source.

Herein, the local coordination numbers of the rare earth ions and the crystal field can be tailored by means of the glass composition to yield the desired color emission. The broad adsorption of the rear earth ions during the transitions 4f→5d (e.g. Eu²⁺: 4f⁶5d¹→4f⁷ or at Ce) is used to absorb the light of a semiconductor emitter emitting a short wavelengths spectrum. The emission is then performed in a spectral range shifted more to longer wavelengths.

The absorption and emission characteristics of the glass body are primarily influenced by the amount of doping with rear earth ions. The optical transitions of 4f electron systems of Europium can be influenced by the glass composition only to a limited extent. However, the base glass can be optimized with respect to its optical characteristics independently from the doping with rear earth ions to yield in particular a high quantum efficiency of the electron transitions (“low phonon energy glass”) and to yield a high UV-transmissivity when light sources emitting in the UV-region are used, and to tailor the glass to emit at a particular color temperature range.

Therefore, a wide variety of base glasses may be used for doping with rear earth ions, if they are particularly selected to have a maximum phonon energy as small as possible and to have a UV-transmissivity as high as possible.

Principally, all glasses based on the classical glass formers SiO₂, B₂O₃, and P₂O₅ or GeO₂ are suitable. A wide variety of these glasses is known for technical and optical applications. These glasses include lead-silicate glasses (flint glasses), soda-lime glasses (crown glasses), alkali-alkaline-earth silicate glasses, lanthanum oxide borate glasses, barium oxide silicate glasses, chalcogenide glasses and halide glasses.

Such “technical” or “optical” glasses may be tailored with respect to their characteristics by adding other oxides.

To reduce the maximum phonon energies, in particular the content of B₂O₃ is kept as small as possible.

Even when the maximum phonon energy is adjusted in an optimal way, excited rear earth ions may relax undesirably without emission, in particular with OH⁻-groups present in the glass. Therefore, according to the invention it is desired, to make the glass extremely low on OH⁻ which can be obtained by “dry” melting, e.g. by adding halogenides such as Cl⁻, or by blowing dry oxygen or halogenide gas into the melt. In this way a quantum efficiency of the phonon transitions of >80%, preferably >90% can be reached so that a maximum of 20% (preferably only 10% of the excited levels of the non-emitting processes) are relaxed (“low phonon energy glass”).

Also by the addition of oxides of heavy metals or transition metals, in particular Bi, Te, Sb, Ge, Gd, Ga, Pb, V, Nb, the phonon energy will be reduced. The transition metals are highly polarizable and thereby facilitate to broaden the optical transitions (by means of Stark splitting). Such glasses having additions of Bi₂O₃ which are preferably in the range between 10 and 85 mol-% are able to reduce the maximum phonon energies to less than 1000 cm⁻¹ (cf. JP-H3-295828 with respect to upconversion lasers).

To this end, glasses comprising at least 10 mol-% of Bi₂O₃ and at least 10 mol-% Si₂O can be used that may also comprise at least 20 mol-% TeO₂, at least 1 mol-% R₂₀ and at least 1 mol-% ZnO (e.g. 75 mol-% TeO₂, 5 mol-% Na₂O, 20 mol-% ZnO).

With these glasses an optimum between a low phonon energy, broad emission, and high UV-transmissivity can be found.

Also by applying chalcogenide glasses or halogenide glasses instead of oxide glasses the phonon energies may be reduced.

An example for such a base glass is 53 ZrF₃, 20 BaF₂, 3 LaF₃, 3 AlF₃, 20 NaF, 1 ErF₃ (ZBLAN).

Particularly low phonon energies and very positive UV-transmissivities can be reached with glasses of the fluorophosphate type. E.g. a base glass having the following composition may be used:

| | |
|---|---|
| P₂O₅ | >7 |
| MgO + CaO + SrO | >1 |
| Al₂O₃ | >5 |
| BaO | >5 |
| R₂O | >0.1 |
| F/F₂ | >10 |
| SiO₂ | ≧0 |
| other oxides | up to 20. |

Herein the phonon energies are at 1100 cm−1 maximum and the UV-edge is below 250 nm.

According to a further development of the invention, the luminescent glass is an at least partially segregated glass comprising at least a certain fraction of the rear earth ions within the segregated regions.

According to a further embodiment of the invention, the rear earth ions may at least partially be included in crystallite inclusions of the glass.

By these measures, the crystal field and the coordination numbers of the rear earth ions may be tailored in a particular way to match the emission characteristics of the luminescent glass in a broad range to a particular application.

Glasses particularly suited for converting LED light of the blue or UV spectrum (or light of other cold light sources emitting colored light) into white light are highly doped rare earth containing phosphate phosphor glasses.

The invention involves the recognition that certain combinations and dopant levels of rare earth cations, and high total levels of rare earth content, higher than those normally expected to produce bright fluorescence, are desirable in certain white cold light source system designs. Such total rare earth content levels were thought to be previously prohibitive, either because of manufacturing difficulties associated with solubility issues of rare earth materials in glass or because of decreased fluorescence performance, due to issues of either self quenching or quenching of the rare earth excited states by energy transfer to phonon (vibrational) modes within the host glass involved in the fluorescence transitions producing white light, when rare earth concentration levels achieve a critical value. The latter phenomenon is referred to as concentration quenching. See, e.g. U.S. Pat. No. 4,239,645 which discloses that high total neodymium (Nd) oxide contents cause difficulties in oscillating and amplifying a laser glass due to self quenching of Nd excited states by energy transfer between Nd cations and phonon modes within a phosphate host glass.

### BRIEF DESCRIPTION OF THE DRAWINGS

Upon further study of the specification in conjunction with the drawings further objects and advantages of this invention will become apparent to those skilled in the art.

FIG. 1 shows the absorption spectrum of highly doped phosphate phosphor glasses of the present invention.

FIGS. 2 through 4 show the emission spectra of highly doped phosphate phosphor glass examples of the present invention when excited at 370 nm, 380 nm and 410 nm, respectively.

FIG. 5 is a representative image of the chromaticity diagram.

FIGS. 6 through 8 show the chromaticity points for fluorescence from highly doped phosphate phosphor glass examples when excited at 370 nm, 380 nm and 410 nm, respectively.

FIG. 9 and FIG. 10 show a schematic representation of white LED systems prepared with a doped luminescent glass of the present invention.

### DETAILED DESCRIPTION OF THE PREFERRED EMBODIMENTS

Apart from the wide variety of glasses discussed before, particularly phosphate phosphor glasses are disclosed by the current invention for making highly efficient luminescent glasses that are highly doped with rear earth oxides. These glasses will be described in the following.

Phosphor glasses of the present invention comprise P₂O₅, Al₂O₃, alkali earth oxides, and alkaline earth oxides. Preferably, the glass contains a maximum of 4 weight percent, especially a maximum of 2 weight percent, of conventional additives or impurities, such as refining agents (e.g., As₂O₃, Sb₂O₃), antisolarants (e.g., TiO₂, Sb₂O₃, Nb₂O₅) and SiO₂ and ZrO₂ which can enter the glass through dissolution of the melting vessel. The inventive glasses are doped with trivalent lanthanide oxides (oxides of elements 57-71) or trivalent rare earth oxides (lanthanide oxides and oxides of Sc and Y) in an amount exceeding 2 mol %, preferably exceeding 3 mol % and particularly preferably exceeding 4 mol %. Exemplary trivalent lanthanide/rare earth oxides are Y₂O₃, Sc₂O₃, La₂O₃, Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, and Yb₂O₃. The phosphor glasses according to the invention are highly doped with preferably trivalent terbium, europium, and cerium and/or thulium. In these glasses, the oxygen in the metal oxides can optionally be replaced by fluorine up to 90%, or other halogens and anions such as nitrogen and carbon up to 10%.

In general, the glasses have a P₂O₅ content of 50 to 75 mol %, for example, 51, 52, 53, 54, 55, 56, 57, 58, 59, 60, 61, 62, 63, 64, 65, 66, 67, 68, 69, 70, 71, 72, 73, 74 mol %. Further preference is given to glasses having a P₂O₅ content above 60 mol %, more preferably above 65 mol %, even more preferably above 70 mol %. It is believed that higher levels of P₂O₅ enhance the solubility for rare earth ions and reduce harmful quenching of the rare earth excited states involved in the transitions generating fluorescence.

In addition, in general, the glasses have an Al₂O₃ content of 3 to 15 mol %, for example, 4, 5, 6, 7, 8, 9, 10, 11, 12, 13, 14 mol %. Preference is given to glasses having a Al₂O₃ content above 5 mol %, more preferably above 8 mol %, and even more preferably over 10 mol % since these glasses are characterized by improved chemical durability.

The alkali metal oxides used in the inventive glasses are Na₂O, K₂O, Li₂O, Rb₂O and Cs₂O, preferably Na₂O, Li₂O, K₂O and Cs₂O, and especially Li₂O, K₂O and Na₂O. The amount of combined alkali metal oxides is, for example, 0 to 35 mol %, for example, 0.5, 1, 2, 3, 4, 5, 6, 7, 8, 9, 10, 11, 12, 12, 13, 14, 15, 16, 17, 18, 19, 20, 21, 22, 23, 24, 25, 26, 27, 28, 29, 30, 31, 32, 33, 34 mol %, preferably 5 to 30 mol %. These additives enhance meltability of the compositions of this invention.

The alkaline metal oxide used in the inventive glasses are MgO, CaO, SrO and BaO. However, ZnO can be used interchangeably for these alkaline metal oxides. Preferably MgO, BaO and ZnO are the employed metal oxides at levels of, for example, 0 to 35 mol %, for example, 0.5, 1, 1.5, 2, 3, 4, 5, 6, 7, 8, 9, 10, 11, 12, 12, 13, 14, 15, 16, 17, 18, 19, 20, 21, 22, 23, 24, 25, 26, 27, 28, 29, 30, 31, 32, 33, 34 mol %, more preferably 0 to 30 mol %. These additives enhance the chemical durability of the glasses of this invention.

In accordance with one embodiment, the glasses contain trivalent La₂O₃, Tb₂O₃, Eu₂O₃, and Ce₂O₃ in an amount of more than 2 mol %, for example, 2.5, 3.0, 3.5, 4.0, 4.5, 5.0, 5.5, 6.0, 6.5, 7.0, 7.5, 8.0 mol %, etc., preferably more than 3 mol % and even more preferably over 4 mol %. In accordance with another embodiment, the glasses contain trivalent La₂O₃, Tb₂O₃, Eu₂O₃, and Ce₂O₃ and/or Tm₂O₃ in an amount of more than 2 mol %, for example, 2.5, 3.0, 3.5, 4.0, 4.5, 5.0, 5.5, 6.0, 6.5, 7.0, 7.5, 8.0 mol %, etc., preferably more than 3 mol % and even more preferably over 4 mol %.

Phosphor glasses of the present invention can also contain refining agents, such as As₂O₃, and Sb₂O₃, and standard antisolarant additives, such as Nb₂O₅ and TiO₂ (as well as others, e.g. SiO₂, Sb₂O₃ and divalent cerium, CeO₂) that prevent the glasses of this invention from exhibiting discoloration when excited by high levels of UV and blue radiation from excitation LED; as well as small levels of additional components, such as SiO₂, PtO₂, and ZrO₂, that are present in the glass from dissolution of the melting equipment used to manufacture the glass. The combined levels of these other additives normally do not exceed 4 percent on a weight basis.

Glasses of this invention can be conventionally prepared by mixing appropriate amounts of each constituent in a batch which is then charged into a fused silica crucible and melted by induction heating, e.g., 1000° C. to as much as 1500° C. depending on the chosen composition and constituents. The glasses can then be refined at temperatures exceeding, e.g. 1200° C. from typically 2 to 4 hours, again depending on composition and thus melt viscosity, with equal intervals of oxygen and/or nitrogen gas bubbling and stirring. The glasses are then typically cast into steel molds and annealed at the transformation temperature plus about 20° C. for about 2 hours, followed by cooling to room temperature at 30° C. per hour. These procedures were followed in the examples below.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius and, all parts and percentages are by weight, unless otherwise indicated. Examples of the highly doped rare earth containing phosphate phosphor glass of the present invention are disclosed in Table 1.

TABLE 1
Examples of highly doped rare earth containing phosphate phosphor
glasses, glass compositions are expressed on a mol percent oxide basis.

| Oxide | Example 1 | Example 2 | Example 3 | Example 4 | Example 5 | Example 6 | Example 7 |
|---|---|---|---|---|---|---|---|
| P₂O₅ | 67.95 | 68.04 | 68.08 | 68.16 | 68.08 | 67.83 | 67.23 |
| Al₂O₃ | 8.45 | 8.46 | 8.46 | 8.47 | 8.46 | 8.43 | 8.36 |
| Na₂O | | | | | | | |
| K₂O | 9.26 | 9.27 | 9.27 | 9.29 | 9.27 | 9.24 | 9.16 |
| BaO | | | | | | | |
| CaO | | | | | | | |
| La₂O₃ | 7.89 | 9.16 | 10.19 | 10.32 | 10.19 | 7.42 | 8.98 |
| Eu₂O₃ | 3.71 | 1.24 | 1.24 | 1.24 | 1.24 | 1.24 | |
| Tb₂O₃ | 2.62 | 2.63 | 2.63 | 1.32 | 2.63 | 2.63 | |
| Ce₂O₃ | 0.12 | 1.21 | 0.13 | 1.21 | 1.21 | 1.21 | |
| Pr₂O₃ | | | | | | | 2.47 |
| Dy₂O₃ | | | | | | | 3.81 |
| Tm₂O₃ | | | | | | 2.03 | |
| Bubbling | Oxygen | Oxygen | Oxygen | Oxygen | Nitrogen | Oxygen | Oxygen |
| Gas | | | | | | | |

| Oxide | Example 8 | Example 9 | Example 10 | Example 11 | Example 12 |
|---|---|---|---|---|---|
| P₂O₅ | 68.02 | 68.03 | 66.22 | 68.03 | 70.31 |
| Al₂O₃ | 8.45 | 8.45 | 6.97 | 7.17 | 8.74 |
| Na₂O | | | | | 6.30 |
| K₂O | 9.27 | 9.27 | 5.67 | 5.83 | |
| BaO | | | 7.34 | 3.23 | |
| CaO | | | | 1.58 | |
| La₂O₃ | 9.73 | 9.85 | 9.91 | 10.18 | |
| Ce₂O₃ | 0.13 | | 0.12 | 0.13 | 0.13 |
| Tb₂O₃ | 2.63 | 2.63 | 2.56 | 2.63 | 2.72 |
| Eu₂O₃ | 1.24 | 1.24 | 1.20 | 1.24 | 1.28 |
| Pr₂O₃ | | | | | |
| Dy₂O₃ | | | | | |
| Tm₂O₃ | 0.54 | 0.54 | | | |
| Bubbling Gas | Oxygen | Oxygen | Oxygen | Oxygen | Oxygen |

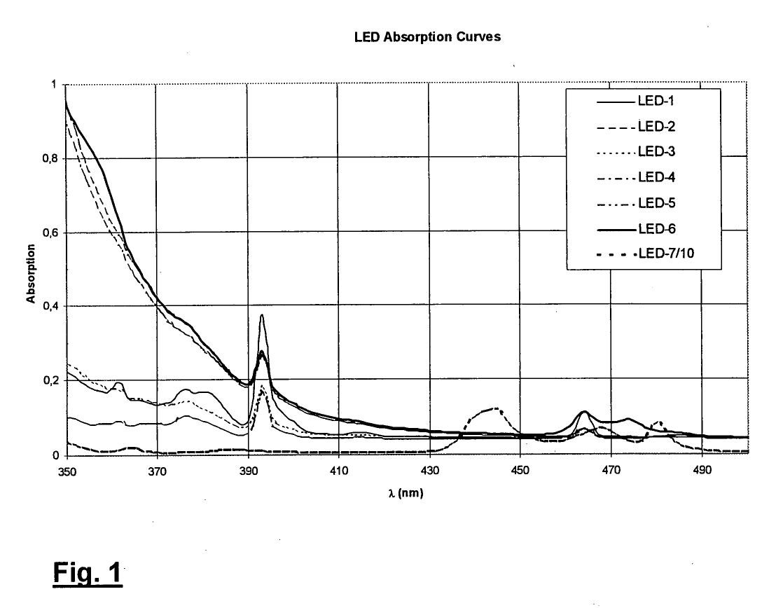

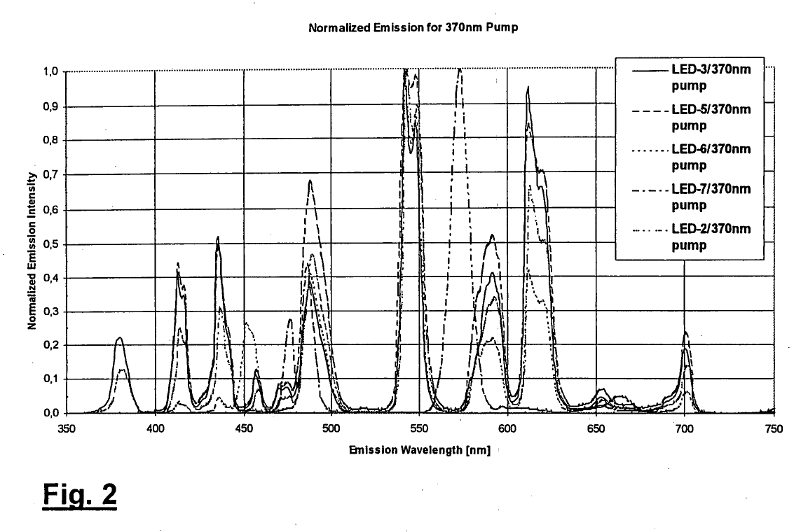

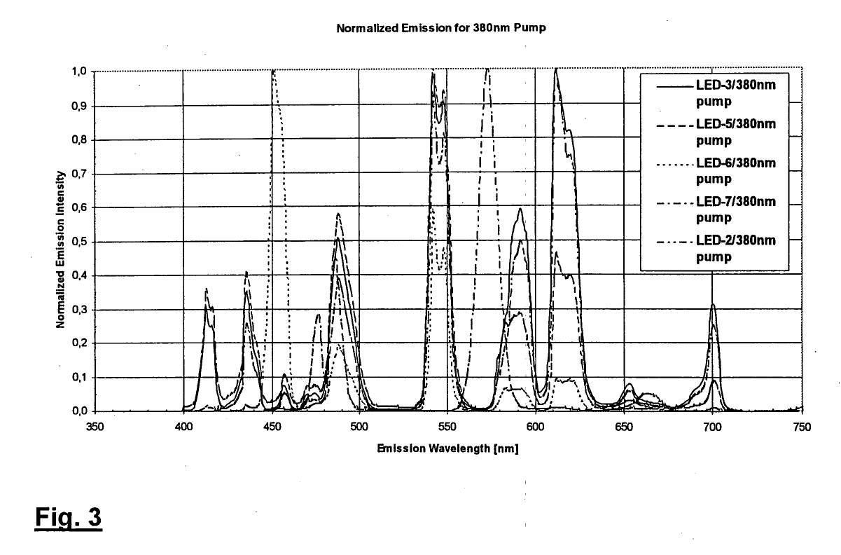

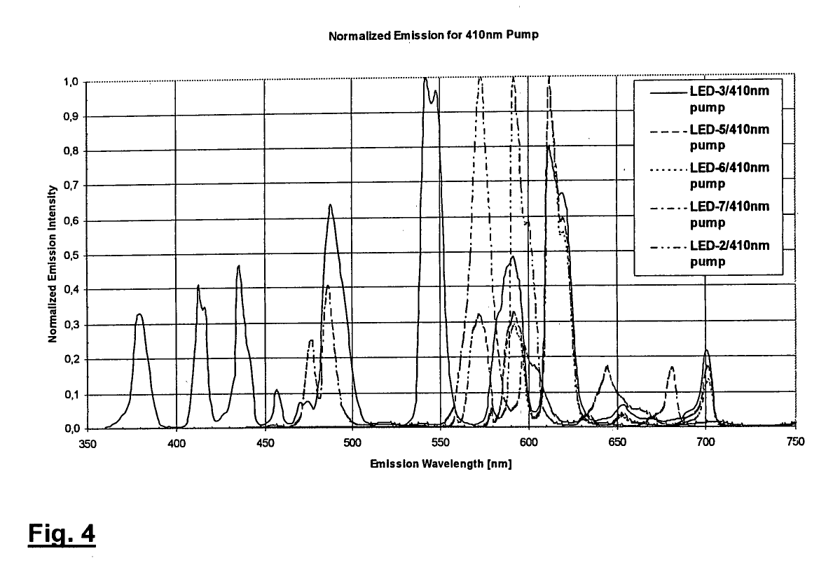

The absorption spectra as recorded with a Perkin Elmer Lambda 900 spectrophotometer of the example phosphate phosphor glasses in Examples 1 through 7 (hereafter referred to as “LED-1” through “LED-7”, respectively) pictured in FIG. 1 provide guidance in regards to the appropriate means by which to energize, or pump, the phosphor glasses with blue or UV emitting LED. When pumped in this way, rare earth cations in the glass are electronically excited and can emit light of various colors depending on the identity of the rare earth. For the case of europium and terbium, this emission is in the red and blue/green part of the visible spectrum, respectively. For the case of cerium and thulium, this emission is in the blue part of the spectrum. For the case of praseodymium and dysprosium, multiple colors are emitted simultaneously. FIGS. 2 through 4 depict the emission fluorescence for the example glasses when pumped in this way at 370 nm, 380 nm and 410 nm center wavelengths with 30 nm bandwidth (FWHM) respectively.

A qualitative measure of the color of emission as perceived by the human eye is prepared by calculating the quantities (see for example the standard “Method of Measuring and Specifying Colour Rendering Properties of Light Sources”, CIE 13.3-1995, published by the Commission Internationale de l'Eclairage, ISBN 3 900 734 57 7):
X=˜x(λ)P(λ)dλ
Y=˜y(λ)P(λ)dλ
Z=˜z(λ)P(λ)dλ
where x(λ), y(λ), and z(λ) are the color matching functions that define the response of the red, green and blue cones within the human eye, respectively, P(λ) is the intensity of the emission as a function of wavelength, λ, and X, Y, and Z are termed the tristimulus values for the fluorescence source. The color matching functions x(λ), y(λ), and z(X) are tabulated in, for example, “Handbook of Colorimetry”, A. C. Hardy, the Massachusetts Institute of Technology, Technology Press, 1936.

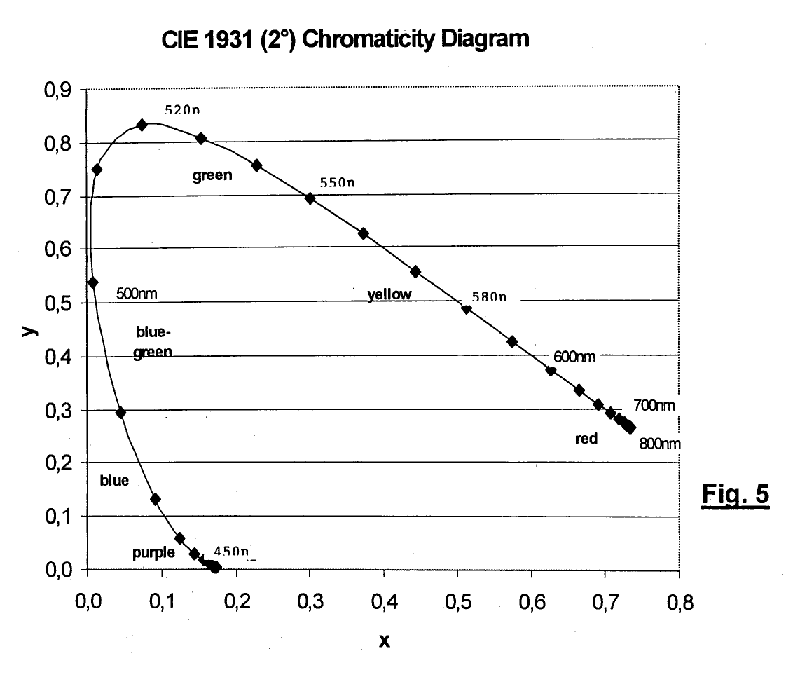

The color of the fluorescence is then quantitatively defined by ratios of these tristimulus values as:
x=X/(X+Y+Z)
and
y=Y/(X+Y+Z)
where x and y are referred to as chromaticity coordinates. In this way, a perfect white color is defined by x=y=⅓. The color of a full range of sources can then be plotted in this way on a chromaticity diagram, see FIG. 5.

However, it is generally regarded in the lighting industry that a range of colors are perceived by the eye as “white” sources. In particular, an object heated to temperatures between about 2700 K and 7000 K (referred to as a blackbody radiator) emits light perceived as attractive for indoor lighting applications. The spectral distribution of intensity with wavelength, λ, as a function of object temperature, T, was first derived by Plank in 1900 (see M. Plank, Verhand. der Deutschen Phys. Gesellschaft, Vol 2, pg 237, 1900) and is given by
I(λ)=2hc²/{λ⁵[exp(hc/λkT)−1]}
where h and k are Plank's constant (6.626×10⁻³⁴ J·s) and Boltzman's constant (1.381×10⁻⁷ J/K), respectively, and c is the speed of light (2.998×10⁸ m/s).

The corresponding chromaticity coordinates for the Plankian curve corresponding to a blackbody radiator at various temperatures is tabulated in, for example, “Color Science”, G. Wyszecki and W. S, Stiles, John Wiley and Sons, 1967; and the representative x and y values that can be plotted on the chromaticity diagram for temperatures between 2700K and 7000K are listed in Table 2.

For this reason, chromaticity coordinates of x=y=⅓ are not alone desirable, but rather a range of x and y falling on or near a Plankian curve. A white light source can thus be defined not by chromaticity coordinates x and y alone, but should also be characterized by a color temperature (CT) of the source in degrees Kelvin.

TABLE 2
Chromaticity Diagram Coordinates for the Plankian curve between
2700 K and 7000 K:
White Blackbody Source Temperatures (2700 to 7000 K)

| T [K] | x | y |
|---|---|---|
| 2700 | 0.4597 | 0.4106 |
| 2800 | 0.4517 | 0.4086 |
| 2900 | 0.4441 | 0.4064 |
| 3000 | 0.4368 | 0.4041 |
| 3100 | 0.4299 | 0.4015 |
| 3200 | 0.4233 | 0.3989 |
| 3300 | 0.4170 | 0.3962 |
| 3400 | 0.4109 | 0.3935 |
| 3500 | 0.4052 | 0.3907 |
| 3600 | 0.3997 | 0.3879 |
| 3700 | 0.3945 | 0.3851 |
| 3800 | 0.3896 | 0.3822 |
| 3900 | 0.3848 | 0.3795 |
| 4000 | 0.3804 | 0.3767 |
| 4100 | 0.3760 | 0.3740 |
| 4200 | 0.3719 | 0.3713 |
| 4300 | 0.3680 | 0.3687 |
| 4400 | 0.3643 | 0.3660 |
| 4500 | 0.3607 | 0.3635 |
| 4600 | 0.3573 | 0.3610 |
| 4700 | 0.3540 | 0.3586 |
| 4800 | 0.3509 | 0.3562 |
| 4900 | 0.3479 | 0.3539 |
| 5000 | 0.3450 | 0.3516 |
| 5200 | 0.3397 | 0.3472 |
| 5400 | 0.3347 | 0.3430 |
| 5600 | 0.3301 | 0.3391 |
| 5800 | 0.3259 | 0.3353 |
| 6000 | 0.3220 | 0.3318 |
| 6500 | 0.3135 | 0.3236 |
| 7000 | 0.3063 | 0.3165 |

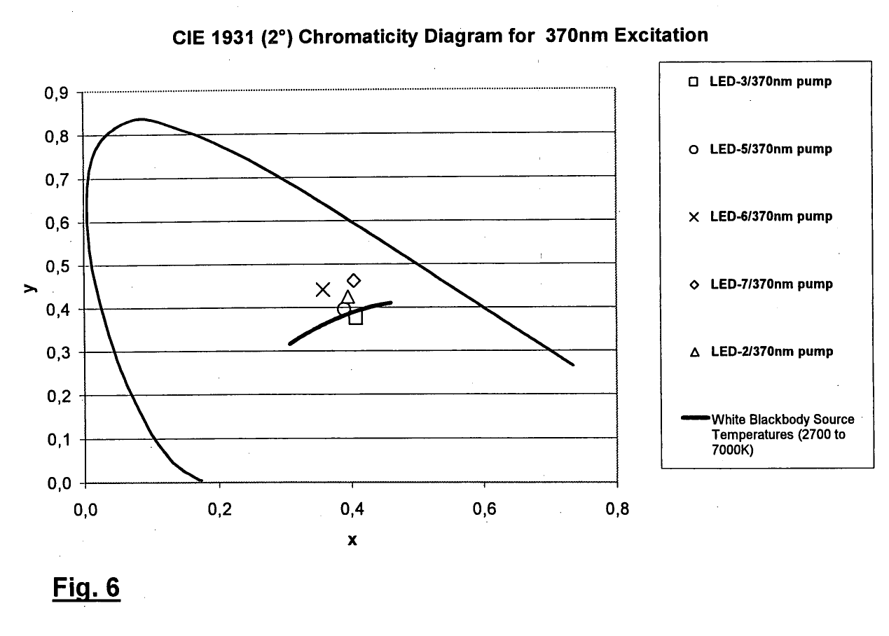

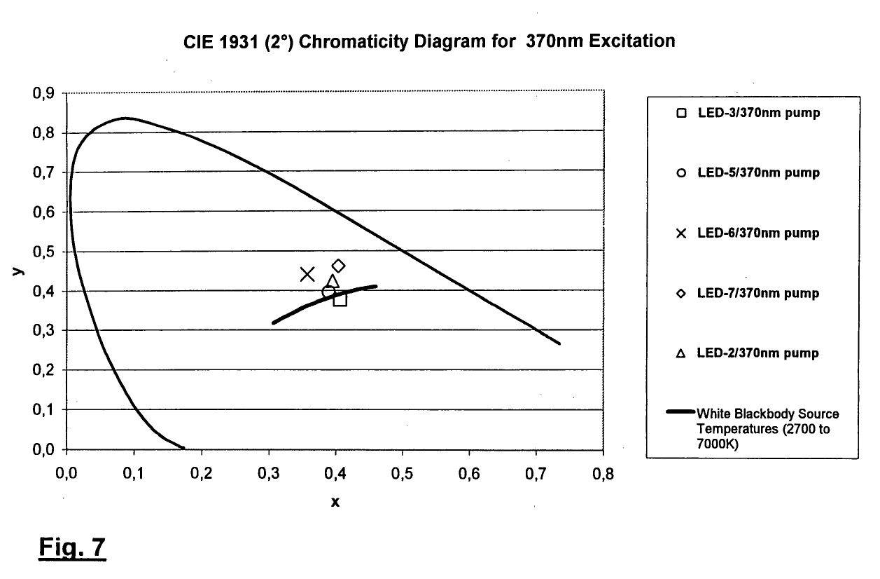

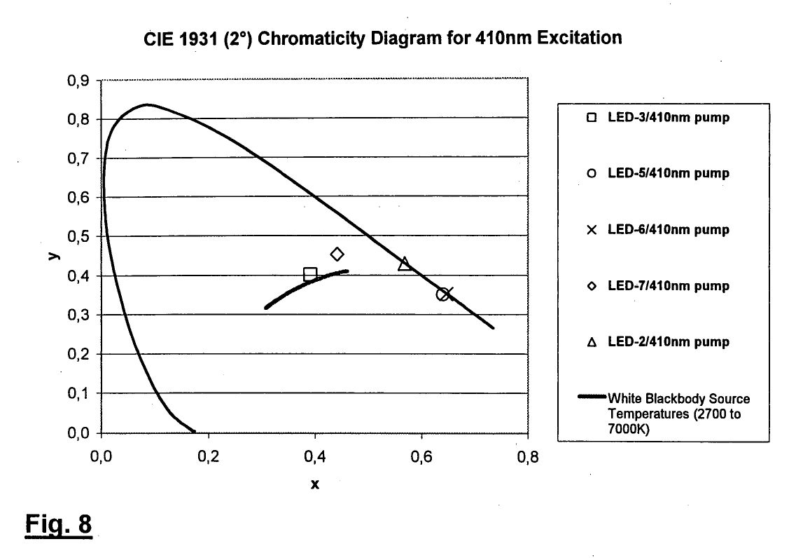

The difference of chromaticity coordinates and color temperature from the Plankian curve is quantified by calculating a chromaticity difference value, AC, between the chromaticity point of the fluorescence source being evaluated (uₛ and vₛ) and the nearest reference point on the Plankian curve (uᵣ and vᵣ):
ΔC=[(uₛ−uᵣ)²+(vₛ−vₜ)²]^{1/2}
where the u and v coordinates are tristimulus values for the fluorescence source under evaluation and the reference source on the Plankian curve given by the standard “Method of Measuring and Specifying Colour Rendering Properties of Light Sources”, CIE 13.3-1995:
u=4X/(X+15Y+3Z)
and
v=9Y/(X+15Y+3Z)
and a practical restriction is imposed that ΔC be less than or equal to 0.011, preferably less than or equal to 0.005 (equal to the tolerance value for ΔC in the standard). For reference, FIGS. 6 through 8 show the chromaticity coordinates positions relative to the Plankian curve from 2700K to 7000K when Examples 1 through 7 are excited at 370 nm, 380 nm and 410 nm, respectively.

It is not alone sufficient that a white source have a CT value between 2700K and 7000K and chromaticity coordinates lying near the Plankian curve between these two temperatures. It is also critical that objects of various colors be perceived by the human eye with correct color rendition. This can be achieved only when the white source has the correct balance of colors and intensities covering the entire response range of the human eye. For example, by proper selection of a source containing proper amounts of only blue and yellow light, a source perceived to the eye as pure white can be prepared. However this source contains no green component and consequently green objects upon illuminated by this source will not be capable to reflect green light to the eye and the green color of the object will not be correctly perceived.

A quantitative value of color rendering capability of a source is given by calculating a color rendering index, CRI, given by the numerical average of eight individual special color rendering indices, R₁ through R₈, as defined by the CIE standard “Method of Measuring and Specifying Colour Rendering Properties of Light Sources”, CIE 13.3-1995.
CRI=(⅛)ΣR₁(i=1 to 8)

A perfect CRI score is 100, and a functional value of CRI is more than 80. The following is a qualitative description of CRI values
CRI >90=close to perfect
CRI >80 to 90=suitable for most applications
CRI of 70 to 80=not as suitable
CRI <70=not suitable as a lighting source

A white light source thus must satisfy three requirements, chromaticity coordinates x and y the analogous color temperature (CT) on or near the Plankian curve between 2700K and 7000K, expressed as a chromaticity difference value (ΔC) of less than 0.011, preferably less than 0.005, and a color rendering index (CRI) value greater than 80, preferably greater than or equal to 85.

The color chromaticity coordinates, x and y, color temperature (CT), chromaticity difference value (ΔC) and color rendering index (CR1) of the example glasses of the subject invention for a variety of excitation wavelengths in the UV and blue portion (between 270 nm and 455 nm) of the electromagnetic spectrum are given in Table 3. Emission spectra were recorded for 30 nm bandwidth excitation centered on the typical LED emission wavelengths indicated in Table 3 using a Jobin Yvon Horiba SPEX FluoroLog-3 spectrofluorometer.

TABLE 3
Color Properties of example of highly doped rare earth containing
phosphate phosphor glasses

| | | | | | | | |
|---|---|---|---|---|---|---|---|
| Color | | | | | | | |
| Property | Example 1 | Example 2 | Example 3 | Example 4 | Example 5 | Example 6 | Example 7 |

For a 370 nm Excitation Wavelength

| | | | | | | | |
|---|---|---|---|---|---|---|---|
| x | 0.47 | 0.39 | 0.41 | 0.61 | 0.39 | 0.36 | 0.40 |
| y | 0.40 | 0.42 | 0.37 | 0.37 | 0.39 | 0.44 | 0.46 |
| CT [K] | 2411 | 3984 | 3261 | 1292 | 3917 | 4886 | 4012 |
| ΔC | 0.005 | 0.015 | 0.011 | 0.027 | 0.006 | 0.029 | 0.029 |
| CRI | 82.65 | 83.33 | 86.75 | 51.75 | 87.87 | 71.56 | −6.46 |

For a 380 nm Excitation Wavelength

| | | | | | |
|---|---|---|---|---|---|
| x | 0.46 | 0.44 | 0.34 | 0.22 | 0.40 |
| y | 0.41 | 0.40 | 0.41 | 0.22 | 0.46 |
| CT [K] | 2751 | 2937 | 5285 | 34463 | 4031 |
| ΔC | 0.001 | 0.001 | 0.023 | 0.014 | 0.027 |
| CRI | 87.09 | 87.42 | 75.00 | 66.34 | −9.13 |

For a 410 nm Excitation Wavelength

| | | | | | |
|---|---|---|---|---|---|
| x | 0.57 | 0.39 | 0.64 | 0.65 | 0.44 |
| y | 0.43 | 0.40 | 0.35 | 0.35 | 0.45 |
| CT [K] | 1781 | 3916 | 1064 | 1044 | 3306 |
| ΔC | 0.007 | 0.007 | 0.001 | 0.0002 | 0.018 |
| CRI | −14.68 | 86.91 | 24.00 | 23.77 | 12.28 |

For a 440 nm Excitation Wavelength

| | |
|---|---|
| x | 0.64 |
| y | 0.34 |
| CT [K] | 1051 |
| ΔC | 0.003 |
| CRI | 21.02 |

For a 455 nm Excitation Wavelength

| | | | |
|---|---|---|---|
| x | 0.63 | 0.62 | 0.62 |
| y | 0.34 | 0.34 | 0.34 |
| CT [K] | 1063 | 1103 | 1103 |
| ΔC | 0.004 | 0.008 | 0.008 |
| CRI | 25.58 | 27.21 | 31.62 |

| | | | | | |
|---|---|---|---|---|---|
| Color | | | | | |
| Property | Example 8 | Example 9 | Example 10 | Example 11 | Example 12 |

For a 370 nm Excitation Wavelength

| | | | | | |
|---|---|---|---|---|---|
| x | 0.37 | 0.37 | 0.39 | 0.39 | 0.39 |
| y | 0.39 | 0.39 | 0.41 | 0.41 | 0.40 |
| CT [K] | 4504 | 4486 | 4017 | 4015 | 4009 |
| ΔC | 0.007 | 0.006 | 0.008 | 0.008 | 0.007 |
| CRI | 83.74 | 84.52 | 83.75 | 83.71 | 83.87 |

For a 380 nm Excitation Wavelength

| | | | | | |
|---|---|---|---|---|---|
| x | 0.44 | 0.45 | 0.44 | 0.44 | 0.44 |
| y | 0.43 | 0.43 | 0.40 | 0.40 | 0.40 |
| CT [K] | 3060 | 3050 | 2915 | 2913 | 2951 |
| ΔC | 0.008 | 0.008 | 0.001 | 0.0007 | 0.0005 |
| CRI | 86.79 | 86.90 | 87.38 | 87.50 | 87.38 |

It will be noted that several of the examples achieve properties that may fall outside the scope of part of this invention. These examples thus demonstrate the importance of certain factors in achieving the properties of this invention and, most importantly, provide valuable guidance as to how routine experimentation may be utilized to select compositions within the general composition space defined for this invention and excitation conditions (wavelength and excitation bandwidth) which have resultant properties defined for this invention.

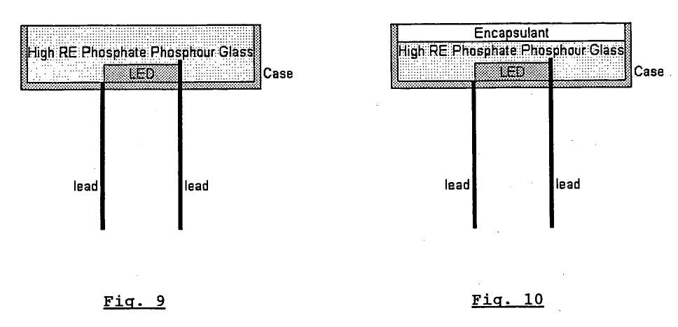

A white LED system of this invention can be constructed in a number of ways. FIG. 9 is a schematic drawing of a white LED system prepared from a highly doped rare earth phosphate phosphor glass prepared in the form of a solid disk. In FIG. 9, the glass component is placed between the EV or blue LED active element and the outside environment. The disk serves a double role as a hermetic barrier between the LED element and the ambient air and as a white light generation source in the white LED. The UV or blue emission from the LED is absorbed by the highly rare earth doped glass and re-emitted as white light. FIG. 10 is a schematic drawing of a white LED system prepared from a highly doped rare earth phosphate phosphor glass prepared in the form of a glass powder that is placed in a second suitable host matrix, placed adjacent to the UV or blue LED element, and jointly encapsulated by a epoxy, plastic, or other organic potting material common within the LED industry. As before, in FIG. 10, the UV or blue emission from the LED is absorbed by the highly rare earth doped glass and re-emitted as white light. Similar devices can be prepared by other technologies, for example the glass composition can be prepared by sputtering processes or as a sol gel solution, or multiple UV and blue emitting LED can be placed adjacent to the high rare earth doped phosphate phosphor glass.

The entire disclosures of all applications, patents and publications cited above or below, is hereby incorporated by reference.

From the foregoing description, one skilled in the art can easily ascertain the essential characteristics of this invention and, without departing from the spirit and scope thereof, can make various changes and modifications of the invention to adapt it to various usages and conditions.

1. A luminescent phosphate phosphor glass doped with at least one trivalent rare earth cation in an amount exceeding 1 mol-% on an oxide basis, the glass comprising at least 50 mol-% of P₂O₅, further comprising 3 to 15 mol-% of Al₂O₃ and 0.5 to 35 mol-% of alkali metal oxides and up to 50 mol-% of at least one component selected from the group formed by alkaline earth oxides and ZnO, and further comprising up to 4 wt.-% of at least one component selected from the group consisting of SiO₂, ZrO₂, As₂O₃, Sb₂O₃, TiO₂, and Nb₂O₅.

2. The luminescent glass of claim 1, the glass comprising 0 to 50 mol-% of at least one component selected from the group consisting of alkali earth oxides, alkaline earth oxides and ZnO, said glass having color chromaticity coordinates, x and y, and color temperature, CT, near the Plankian curve between 2700K and 7000K, expressed as a AC value of less than or equal to 0.011, and a color rendering index >80.

3. The luminescent glass of claim 1, comprising 5 to 35 mol-% of at least one alkali metal oxide.

4. The luminescent glass of claim 1, wherein up to 90% of the oxygen contained within the glass is replaced by fluorine.

5. The luminescent glass of claim 1, wherein up to 10% of the oxygen contained within the glass is replaced by at least one anion different from oxygen.

6. The luminescent glass of claim 1 comprising more than 2 mol-% RE₂O₃ where RE₂O₃ refers to more than one trivalent rare earth oxide selected from the group consisting La₂O₃, Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, and Yb₂O₃.

7. The luminescent glass of claim 1 comprising at least one trivalent rare earth cation selected from the group consisting of cations of Ce, Th, Eu, Tm, Pr and Dy.

8. A luminescent glass comprising a base glass doped with 0.001 to 30 wt.-% of rare earth oxides on an oxide basis, said base glass comprising 1 wt.-% of water at the most, and further comprising 1 wt.-% of B₂O₃ at the most.

9. The luminescent glass of claim 8, wherein said base glass is a glass selected from the group consisting of an alkaline-earth silicate glass, a lead-silicate glass (flint glass), a soda-lime glass (crown glass), an alkali-alkaline-earth silicate glass, a lanthanum oxide borate glass, a barium oxide silicate glass, a chalcogenide glass, and a halide glass.

10. The luminescent glass of claim 8, wherein said base glass comprises at least one oxide of a metal selected from the group consisting of heavy metals and transition metals.

11. The luminescent glass of claim 8, wherein said base glass comprises at least one oxide of a metal selected from the group consisting of Bi, Te, Sb, Ge, Gd, Ga, Pb, V, Nb.

12. The luminescent glass of claim 8, wherein said base glass comprises (in wt.-%):

| | |
|---|---|
| P₂O₅ | >7 |
| MgO + CaO + SrO | >1 |
| Al₂O₃ | >5 |
| BaO | >5 |
| R₂O | >0.1 |
| F/F₂ | >10 |
| SiO₂ | ≧0 |
| other oxides | up to 20, |

wherein R₂O is an alkali oxide.

13. The luminescent glass of claim 12, wherein said base glass comprises 0.1 wt.-% of water at the most.

14. The luminescent glass of claim 12, wherein said base glass, apart from any unintended contaminants, is free of nitrides.

15. A luminescent glass comprising 0.001 to 30 wt.-% of rare earth oxides on an oxide basis, said luminescent glass comprising regions selected from the group consisting of at least partially segregated glass regions and crystalline regions, at least some of said regions comprising rare earth ions.

16. The luminescent glass of claim 15 wherein at least 30% of said rare earth oxides are contained within said at least partially segregated glass regions.

17. The luminescent glass of claim 15 wherein at least 50% of said rare earth oxides are contained within said at least partially segregated glass regions.
